(19) United States
(12) Patent Application Publication
(10) Pub. No.: US 2004/0172361 A1
(43) Pub. Date: Sep. 2, 2004

(54) Dutch account settlement method

(75) Inventors: Yoshitaka Nakata, Yokohama (JP); Yoshitsugu Morooka, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/377,921

(22) Filed: Feb. 28, 2003

(51) Int. Cl. G06F 17/60

(52) U.S. Cl. 705/40

(57) ABSTRACT

After a card user pays money for a value of services by using the card, it often occurs that a third party pays a fraction or the whole of the money paid by the card user. A conventional card settlement is insufficient for this purpose. To solve this, when money is paid to a service provider, the money is paid by using a credit card of a representative, and thereafter a server computer of a settler including a credit card company presents information necessary for a Dutch account payment process to a Dutch account payer via a network.

### BACKGROUND OF THE INVENTION

The present invention relates to techniques for account settlement. More particularly, the invention relates to techniques for realizing a card settlement method. The card is intended in this specification to mean credit cards, various cards having a credit card function (employee ID cards, student ID cards and the like having also a credit card function), debit cards and the like.

A settlement method using a card including a credit card is widely used nowadays by real shops, purchase sites (electronic shops) on the Internet and the like. Settlement of so-called Dutch or fifty-fifty accounts is also made between persons who drink and eat together. Dutch account settlement by a party organizer using a credit card is disclosed, for example, in the patent document 1 (JP-A-2001-155257).

This patent document 1 discloses a settlement terminal which performs an account settlement process for a Dutch account of a customer card 5 of each of participants when the Dutch account is requested. More in detail, when a Dutch account is requested, a Dutch account is settled by using each of a plurality of customer cards after calculation of an input total charge by using the number of Dutch account payers and each Dutch account ratio.

### SUMMARY OF THE INVENTION

If a plurality of persons receive services including drinking and eating or purchase commercial goods and pay the charge by Dutch accounts, a representative (party organizer) often settles the account presented by a provider such as a shop. The patent document 1 is, however, associated with some problem that cards of all persons (designated payers) required to settle the Dutch accounts are prepared to make a settlement at the settlement terminal by using each card, which takes much labor.

Also according to the patent document 1, each Dutch account ratio is determined at least when the payment is made at the shop. In some Dutch account cases, a Dutch account ratio (the charge incurred to each person) is determined after the total charge is decided. Generally, there is not so long a time for the payment after the provider (shop) shows the total charge. With the patent document 1, it is therefore unable to determine the Dutch account ratio (the charge incurred to each person) composedly and there is a risk of calculating an erroneous ratio or an unfair ratio.

According to the invention, when money is paid to a service provider, the money is paid by using a credit card of a representative, and thereafter a server computer of a settler including a credit card company presents information necessary for a Dutch account payment process to a Dutch account payer via a network. As the information to be presented, the server of the settler may use transaction identification information for identifying a transaction. In this invention, the information may be presented from the representative to each Dutch account payer.

More in detail, the invention has the following structure. A system is used in which a representative apparatus used by a representative, a Dutch account payer apparatus used by each Dutch account payer, an affiliated shop apparatus used by an affiliated shop which provides services and the like, and a settler apparatus used by a settler are all interconnected by a network.

First, the representative performs a payment process relative to the affiliated shop apparatus by using a credit card. Next, the affiliated shop apparatus transmits settlement request information to the settler apparatus. The settlement request information is used for requesting a settlement process and contains user identification information for identifying a credit card user (or representative apparatus identification information for identifying the representative apparatus). These processes may be a process similar to a normal payment process. Next, the settler apparatus judges whether the transaction to be settled by the settlement request information is to be subjected to a “Dutch account process”. If the transaction is to be subjected to the “Dutch account process”, the transaction identification information for identifying the transaction is presented to the representative apparatus by using the user identification information. The settler apparatus stores a correspondence between the transaction identification information, user identification information and settlement money amount. The representative apparatus notifies the received transaction identification information to each Dutch account payer. Each Dutch account payer executes a payment process for the money amount to be paid, by using the transaction identification information. The payment process includes (1) the process by which the Dutch account apparatus executes the payment process relative to the settler apparatus by using a credit card and (2) the process of performing “reception” of a cash at a convenience store. The process (1) may be executed by using a process similar to a payment process presently used by so-called Internet shopping.

The judgement whether the “Dutch account process” is to be executed may be made in accordance with transaction specifying information received beforehand from the representative apparatus. The transaction specifying information contains information of a transaction day (service providing day). The judgement is made through comparison between the settlement request information including the transaction day transmitted from the affiliated shop apparatus and the information transmitted beforehand from the representative apparatus. In this case, the judgement may be made by transmitting information representative of a transaction period from the representative apparatus and checking whether the transaction date transmitted from the affiliated shop apparatus is in the transaction period.

The judgement may be made through comparison between the representative identification information transmitted from the affiliated shop apparatus and the representative identification information contained in the settlement request information transmitted from the affiliated shop apparatus. The representative identification information contains a card number for identifying the card itself.

As the transaction specifying information, the transaction identification information may be used. In this case, the representative apparatus accesses the settler apparatus in advance to acquire the transaction identification information. For the payment process at the affiliated shop, the transaction identification information is notified to the affiliated shop apparatus. The affiliated shop apparatus transmits the settlement request information including the transaction identification information to the settler apparatus. If the transmitted transaction information satisfies predetermined conditions, the settler apparatus judges that the “Dutch account process” is to be executed. Satisfying the predetermined conditions includes the case that the transaction identification information transmitted from the affiliated shop apparatus is coincident with the transaction identification information stored in advance in the settler apparatus. In this case, the transaction identification information necessary for executing the “Dutch account process” may be stored beforehand in the settler apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the system structure according to first and second embodiments.

FIG. 2 is a diagram showing a Dutch account use data master DB 108.

FIG. 3 is a diagram showing a sale collection master DB 107.

FIG. 4 is a diagram showing a Dutch account payment service master DB 109.

FIG. 5 is a diagram of a Dutch account payer conditions master DB 110.

FIGS. 6 to 8 are flow charts illustrating the operation of the first embodiment.

FIG. 9 is a diagram showing a data table of the Dutch account payment service master DB according to the second embodiment.

FIG. 10 is a diagram of a data table of the Dutch account payer conditions master DB.

FIGS. 11 to 14 are flow charts illustrating the operation of the second embodiment.

### DESCRIPTION OF THE EMBODIMENTS

The first embodiment of the invention will be described with reference to the accompanying drawings.

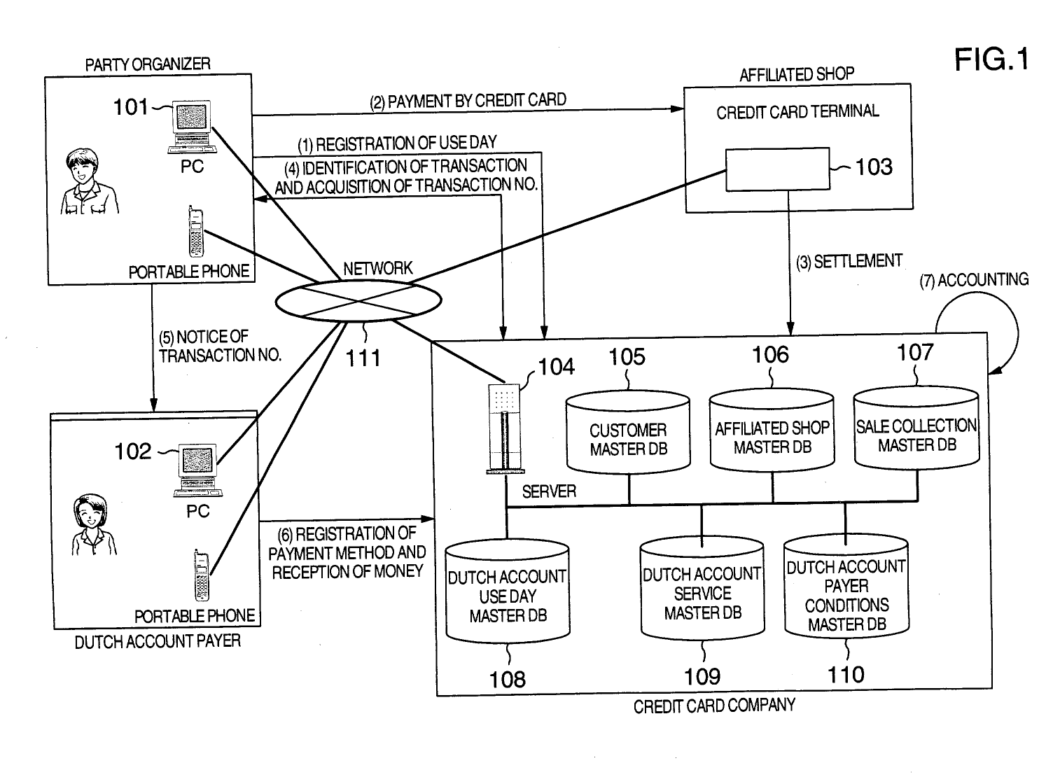

FIG. 1 shows the system structure of the first embodiment which is constituted of: a representative apparatus 101 used by a credit card user, i.e., a representative or party organizer; a Dutch account payer apparatus 102 used by a Dutch account payer or payers who pay a fraction or the whole of the charge paid by the party organizer; an affiliated shop credit card terminal 103; a credit card company server 104, and master DBs 105 to 110. The representative apparatus 101, Dutch account payer apparatus 102, credit card terminal 103 and credit card company server 104 are interconnected by a network 111 and have a processor for processing information in accordance with a program capable of being stored in a storage medium. Each apparatus, terminal or server has a connection device connected to the processor for the connection to the network 111. The representative apparatus 101 and Dutch account payer apparatus 102 may be a so-called personal computer, a PDA or a portable phone.

FIG. 1 illustrates the outline of the procedure of account settlement (first embodiment) to be made by each Dutch account payer who pays a fraction or the whole of the payment made by the party organizer after the organizer settled the account by using a card.

The outline of the procedure of the first embodiment will be described.

First, a party organizer accesses the home page of the credit card company via the representative apparatus 101 and registers a credit card No. for identifying the credit card to be used, an intention to pay by a Dutch account and a use period (a specific day is also available) (Step 1). This registration may be made after credit card payment to be described later at (Step 2). A mail address, a telephone number and the like are also registered which are used when information is supplied to the party organizer.

Next, the party organizer pays the total charge of the Dutch account to the affiliated shop by using the credit card (Step 2).

Next, the affiliated shop requests the credit company to settle the charge paid at Step 2 (Step 3). In this case, the credit card company server 104 creates a transaction No (Step 3).

Next, the credit card company notifies the party organizer of a transaction No. for identifying the transaction for the settlement requested by the affiliated shop and the contents of the transaction (Step 4). This notice is made by using the registration contents entered at Step 1. If the transaction day is in the use period, the contents of the transaction and the transaction No. are notified to the party organizer. If the party organizer registers a plurality of transactions, the credit card company presents the party organizer with the transactions and the party organizer identifies each transaction for which the Dutch account is to be settled. The credit card company registers the transaction No. of the identified transaction in the Dutch account service master DB (Step 4). The transaction No. may be the home page address of the credit card company server 104, the home page address corresponding to each transaction.

Next, the party organizer notifies the transaction No. to each Dutch account payer. This notice may be made by an electronic mail, voices or post office mail (Step 5).

Next, the Dutch account payer notified of the transaction No. makes a payment procedure relative to the credit company (Step 6). For example, the Dutch account payer accesses the credit card company server 104 and confirms the contents of the transaction by using the transaction No. After the confirmation, the Dutch account payer registers a payment method (credit card, bank transfer, reception at a convenience store, or the like). In this case, the Dutch account payer may newly subscribe to a credit card of the credit card company to settle the account by using the credit card. If a card of another company is to be registered, the credit card company also performs credit management. The Dutch account payer pays the charge to a credit card company account in accordance with the payment method registered by the Dutch account payer. If the bank transfer or reception at a convenience store is used, the transaction No. is written after the name of the transfer person.

The credit card company confirms from the transfer person name and transaction No. whether the Dutch account payer has paid the charge of the transaction (Step 7). After the confirmation, this payment is notified to the party organizer (reference from the party organizer may be made) and the money received is subtracted from the total charge paid by the party organizer. The Steps (6) and (7) are repeated before the settlement time limit, the final charge of the party organizer is notified and this final charge is billed.

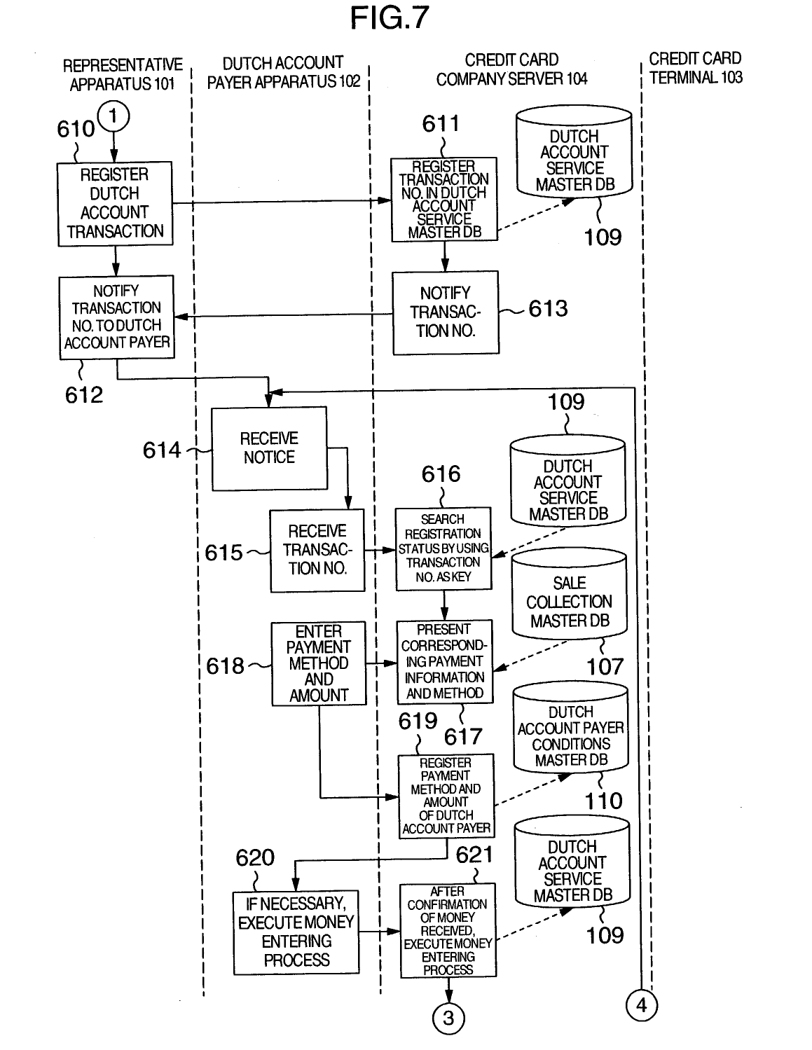

Next, with reference to FIGS. 6 to 8, the details of the process flow at each apparatus of the first embodiment will be described.

First, in response to an input from the party organizer, the representative apparatus 101 accesses the credit card company server 104 and transmits the card No. and the Dutch account use period to the credit card company server 104 (Step 601). In the first embodiment, the use period is represented by a use start day and a use end day. If the use day is deterministic, the use start day and use end day may be the same day. The specified day (one or more days) may be transmitted. If the transmitted information satisfies the predetermined conditions, the credit card company server 104 judges that the Dutch account can be utilized. The satisfied predetermined conditions include that information to the effect that the Dutch account is utilized is received and that the information at Step 601 is transmitted to a specified address. In the first embodiment, instead of the credit card No., a customer number of the credit card services may be used. In this case, by reducing the number of digits of the customer number more than the credit card No. (16 digits), the amount of data to be processed can be reduced.

Next, the credit card company server 104 registers the contents including a use period transmitted at Step 601 in the Dutch account use day master DB 108 (Step 602).

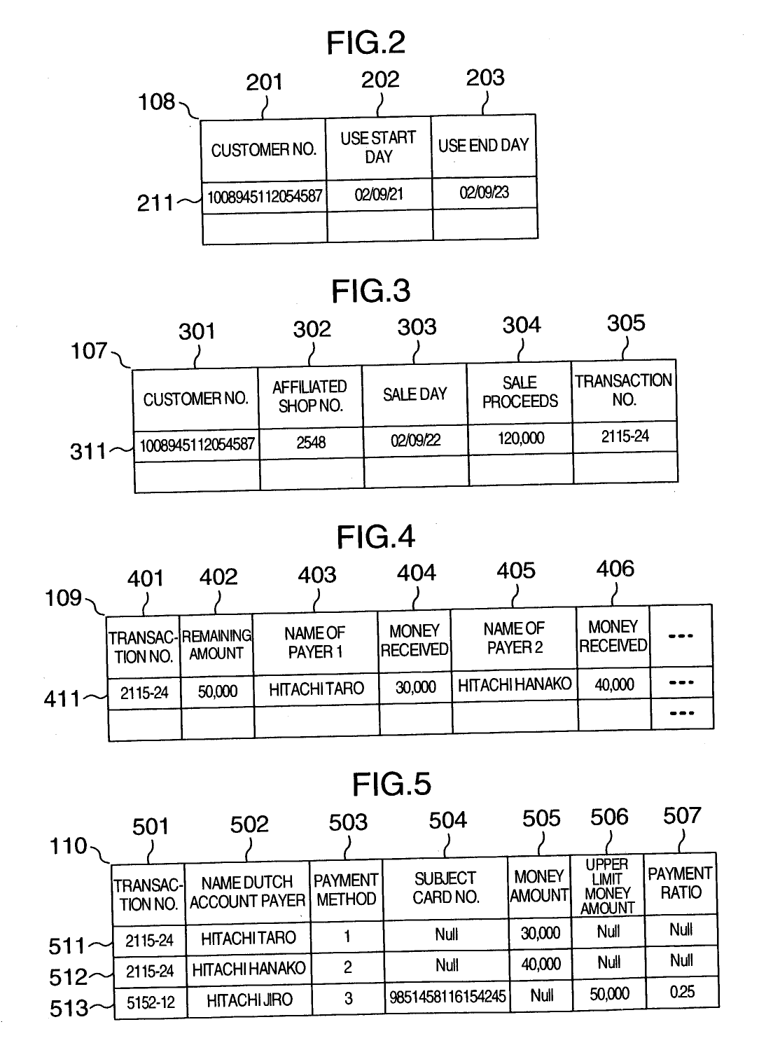

The contents of the Dutch account use day master DB 108 are shown in FIG. 2. Items of the credit card No. 201, start day 202 and end day 203 of the Dutch account use period transmitted at Step 601 are stored.

A payment process for the supply of services or commercial goods is executed. This process includes that the representative apparatus 101 transmits settlement information for the settlement by the credit card (Step 603). If the affiliated shop is not a purchase site on the Internet but an affiliated real shop, Step 603 may be omitted. In this case, the credit card is presented to a shop clerk to perform a general payment process.

Next, the credit card terminal 103 executes a settlement process corresponding to the payment process. In the first embodiment, the credit card terminal 103 transmits settlement request information to the credit card company server 104 (Step 604). The settlement request information includes the credit card No. and use period transmitted at Step 601. The settlement request information also contains sale proceeds of the affiliated shop, information on services (commercial goods) to be sold, and the affiliated shop No. for identifying a sale day and the affiliated shop.

Next, the credit card company server 104 creates the transaction No. corresponding to the settlement request information and stores sale information in the sale collection master DB 107 (Step 605).

FIG. 3 shows the contents of the sale collection master DB 107. This DB stores items of the credit card No. 301, affiliated company No. 302, sale day 303, and sale proceeds 304, in correspondence with the information transmitted at Step 604. Another item 305 corresponding to the transaction No. created by the credit card company server 104 is also stored.

Next, the credit card company server 104 executes the payment process of the sale proceeds relative to the affiliated shop (affiliated shop No. 2548). The payment process includes a process of transmitting to a bank settlement system an account transfer instruction relative to the affiliated shop account.

Next, the credit card company server 104 judges whether the transaction corresponding to the settlement request information is related to the Dutch account (Step 607). As an example of this judgement, the credit card No. corresponding to the sale information registered at Step 605 is searched from the Dutch account use day master DB 108, and if the credit card No. is stored in this DB, it is judged whether the sale day is in the use period (use start day 202, use end day 203) stored in the Dutch account use master DB 108. If it is judged that the use day is in the use period, the credit card company server 104 notifies the transaction contents information to the representative apparatus corresponding to the registered credit card No (Step 609). The transaction contents information contains the information stored in the sale collection master DB 107. The information for identifying the services (commercial goods) to be sold, transmitted at Step 604, may also be contained. Step 609 includes a process of notifying the transaction No. as the transaction contents information and referring to other information by using the transaction No.

The transaction No. includes a URL assigned to each transaction. The transaction contents may be referred to by accessing URL. At Step 609, if there are a plurality of transactions, each of the transactions is notified.

If it is judged at Step 607 that the transaction is not related to the Dutch account, the flow advances to Step 608 whereat a request process is executed relative to the party organizer identified by the credit card No.

Next, the representative apparatus 101 receives the notified transaction contents. In accordance with the received transaction contents information, the transaction contents are output. The transaction contents contain the information stored in the sale collection master DB 107 and the information for identifying the services (commercial goods) to be sold. The output contents allow the party organizer to confirm the transaction contents. If there are a plurality of card settlements during the use period or on a specific day, the information on what transaction number corresponds to the Dutch account transaction is registered from the representative apparatus 101 into the credit card company server 104 (Step 610).

The credit card company server 104 registers the transaction No. registered at Step 610 or the transaction No. judged as the Dutch account at Step 609, in the Dutch account service master DB 109 (Step 611). Namely, the transaction No. is recorded in the transaction No. item 401 shown in FIG. 4, and the sale proceeds are recorded in the remaining amount item 402. The transaction No. may be notified not at Step 609 but at this time (Step 613).

Next, the representative apparatus 101 notifies the transaction No. notified at Step 609 or Step 613 to the Dutch account payer apparatus 102 (Step 612). In this case, the transaction No. together with the home page address of Dutch account services of the credit card company server 104 may be notified. Although not shown in FIGS. 6 to 8, a plurality of Dutch account payer apparatuses 102 may be used.

The representative apparatus 101 may notify the money amount to be paid to the Dutch account payer apparatus 102. The money amount to be paid may be calculated properly from the sale proceeds by the party organizer.

Next, the Dutch account payer apparatus 102 receives the information from the representative apparatus 101 (Step 614). In accordance with the transaction NO., the payment process for the corresponding Dutch account payer starts. First, the Dutch account payer apparatus 102 receives the notified transaction No. and accesses the home page of Dutch account services of the credit card company server 104 (Step 615). An input of the notified transaction No. may be entered manually or mechanically.

The credit card company server 104 searches the contents of the Dutch account service master DB 109 corresponding to the transaction No. entered from the Dutch account payer apparatus 102 (Step 616). The credit card company server 104 presents the searched contents to the Dutch account payer apparatus 102. In this presentation, at least the remaining amount corresponding to the transaction No. is presented. The contents in the sale collection master DB may also be presented. It is therefore possible to show the transaction contents to the Dutch account payer. At Step 619 available payment methods are presented. The available payment methods include payments by a credit card, a debit card, a bank transfer, reception at a convenience store and the like.

If the transaction No. is URL corresponding to the transaction, the processes at Steps 616 to 619 are as follows. The Dutch account payer apparatus 102 accesses URL. After this access, the credit card company server 104 executes the process similar to that at Step 619.

Next, the Dutch account payer apparatus 102 transmits the payment method selected by the payer to the credit card company server 104 (Step 618). It is assumed herein that the payment method by a credit card is selected. At Step 618 the payment amount and credit card No. entered by the payer are transmitted. Instead of the payment amount, a payment ratio of each payment amount to the total payment amount may be transmitted. As the payment amount, the upper limit amount representative of the maximum payment amount for the transaction may be used. In this case, if the total payment amount of the payer becomes insufficient, the upper limit amount is used for the account settlement.

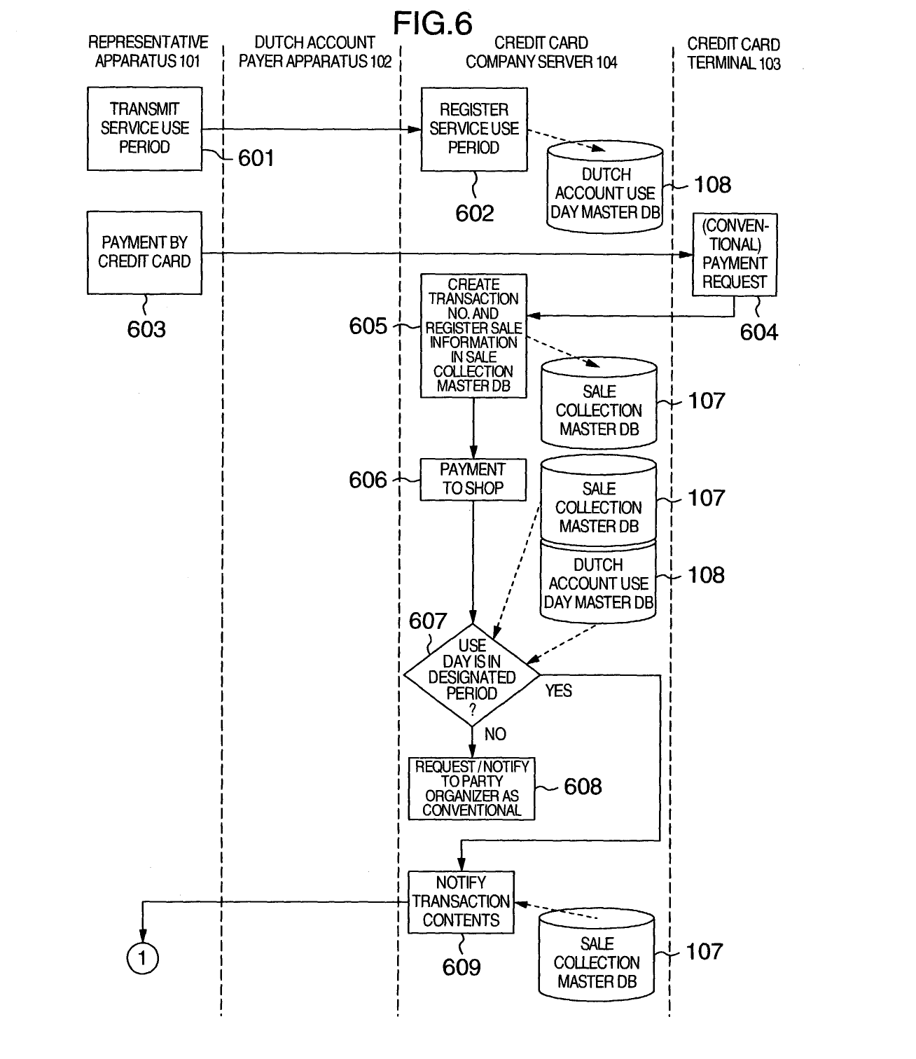

Next, the credit card company server 104 registers the transmitted payment amount in the Dutch account payer conditions master DB 110. An example of the contents of DB 110 is shown in FIG. 5. The Dutch account payer conditions master DB 110 records items of the transaction No. 501, the name 502 of the Dutch account payer, a payment method 503, a credit card No. 504, a paid money amount 505, a payment upper limit 506 and a payment ratio 507. The example shown in FIG. 5 indicates that Hitachi Taro registers to pay 30,000 Yen for the transaction of the transaction No. 2115-24 by means of reception at a convenience store (a payment method 1 is reception at a convenience store). It also indicates that Hitachi Hanako registers to pay 40,000 Yen for the transaction of the transaction No. 2115-24 by means of bank transfer (a payment method 2 is bank transfer).

It also indicates that Hitachi Jiro registers to pay one fourth (payment ratio of 0.25) of the total payment of the party organizer for the transaction of the transaction No. 5152-12 by means of a credit card (a payment method 3 is payment by a credit card) having a card No. 9851458116154245, under the conditions of an upper limit amount of 50,000 Yen.

Next, if necessary, the Dutch account payer apparatus 102 executes a money entering process (Step 620). This process includes a process of instructing payment by bank transfer or credit card. If the bank transfer is to be instructed, the transaction No. may be instructed at the same time. If the Dutch account payer apparatus 102 is not used but bank transfer or reception at a convenience store is used, the transaction No. is written on a payment sheet to pay the money.

After the confirmation of the money received, the credit card company server 104 executes the money entering process (Step 621). After the confirmation of the money received, the credit card company server 104 registers the name of the payer and the entered money amount in the corresponding transaction No. items of the Dutch account service master DB 109 and the entered money amount is subtracted from the remaining amount.

FIG. 4 shows an example of the contents of the Dutch account service master DB 109. This example indicates that a transaction of the transaction No. 2115-24 is registered in the Dutch account service master DB, that Hitachi Taro paid 30,000 Yen and Hitachi Hanako paid 40,000 Yen, and that the remaining amount to be paid by the party organizer is 50,000 Yen.

After the new data is written in the Dutch account service master DB 109, the credit card company server 104 notifies the status to the representative apparatus 101 (Step 622). Namely, at least the information on the new payers and their money amounts is transmitted.

The processes after Step 614 are repeated until a predetermined final time limit (Step 624).

The remaining amount at the final time limit is derived from the Dutch account service master DB 109 and notified to the representative apparatus 101. If there is any remaining amount, a request for the party organizer is performed, i.e., settlement is performed relative to the credit card of the credit card No. registered in the Dutch account use day master DB 108 (Step 625). If the remaining amount becomes 0 before the final time limit, this effect is notified before the final time limit (including the time when the remaining amount becomes 0).

According to the first embodiment, after the party organizer pays the charge by using a credit card, the charge is divided and each Dutch account payer is requested to pay each charge, or before the party organizer pays the charge by using a credit card, a charge of each Dutch account payer is received and thereafter the payment amount of the party organizer is reduced or adjusted. In this manner, the Dutch account can be realized by using a credit card or a debit card. Accordingly a card holder can utilize a Dutch account without holding cash and a use situation of the Dutch account can be broadened.

In the first embodiment, after the party organizer performs a credit card settlement, a request for a Dutch account payer is performed. There is no guarantee that each Dutch account payer pays after the party organizer pays the charge by credit card settlement at the affiliated shop. The party organizer is required to urge each Dutch account payer to pay each charge after the party organizer pays the charge by credit card settlement at the affiliated shop.

In the second embodiment, in order to solve such a problem, before credit card settlement by a party organizer, a credit card company issues beforehand a service No. which is notified to each Dutch account payer to pay each charge in advance.

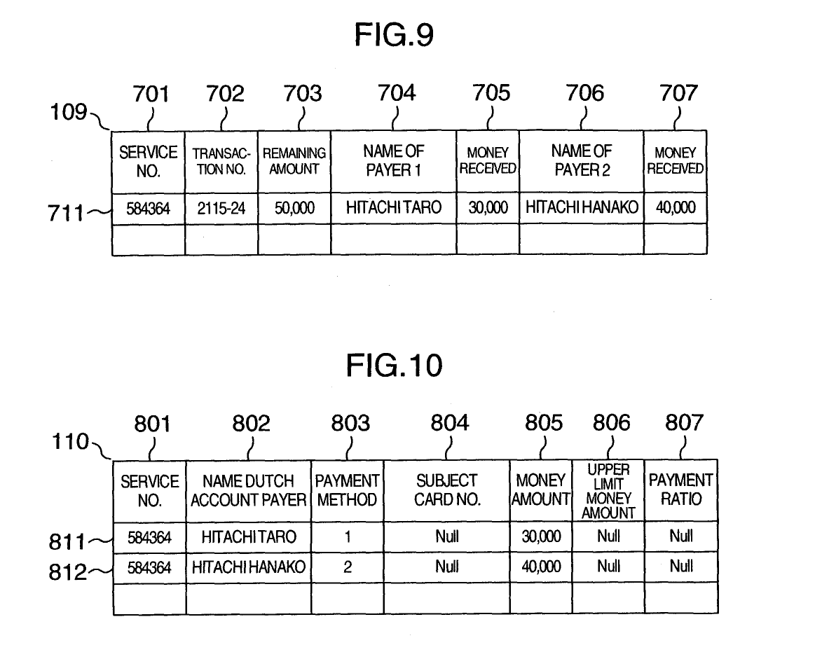

In the second embodiment, the structures of a representative apparatus, a Dutch account payer apparatus, an affiliated shop credit card terminal, a credit card company server and each database are similar to those of the first embodiment, and the description thereof is omitted. The data table of each master DB is similar to that of the first embodiment, excepting that the Dutch account service master DB 109 and Dutch account payer conditions master DB 110 are different from those of the first embodiment. Examples of these data tables are shown in FIGS. 9 and 10. The data table shown in FIG. 9 records items of: a service No. (701) to be issued when a party organizer subscribes to Dutch account services; a transaction No. (702) to be created for each transaction by a credit card company for credit card settlement with an affiliated shop; a remaining amount (703) of a charge to be paid by the party organizer; a name (704) and an entered amount (705) of the first payer among Dutch account payers notified of the service No.; and a name (706) and an entered amount (707) of the second payer to be added with names and entered amounts of the following payers. The data table shown in FIG. 9 indicates that the party organizer asks for the Dutch account and a service No. 584364 is issued, that Hitachi Taro entered 30,000 Yen and Hitachi Hanako entered 40,000 Yen, and that the remaining amount to be paid by the party organizer for the Dutch account charge of the service No. 584364 of the transaction No. 2115-24 is 50,000 Yen.

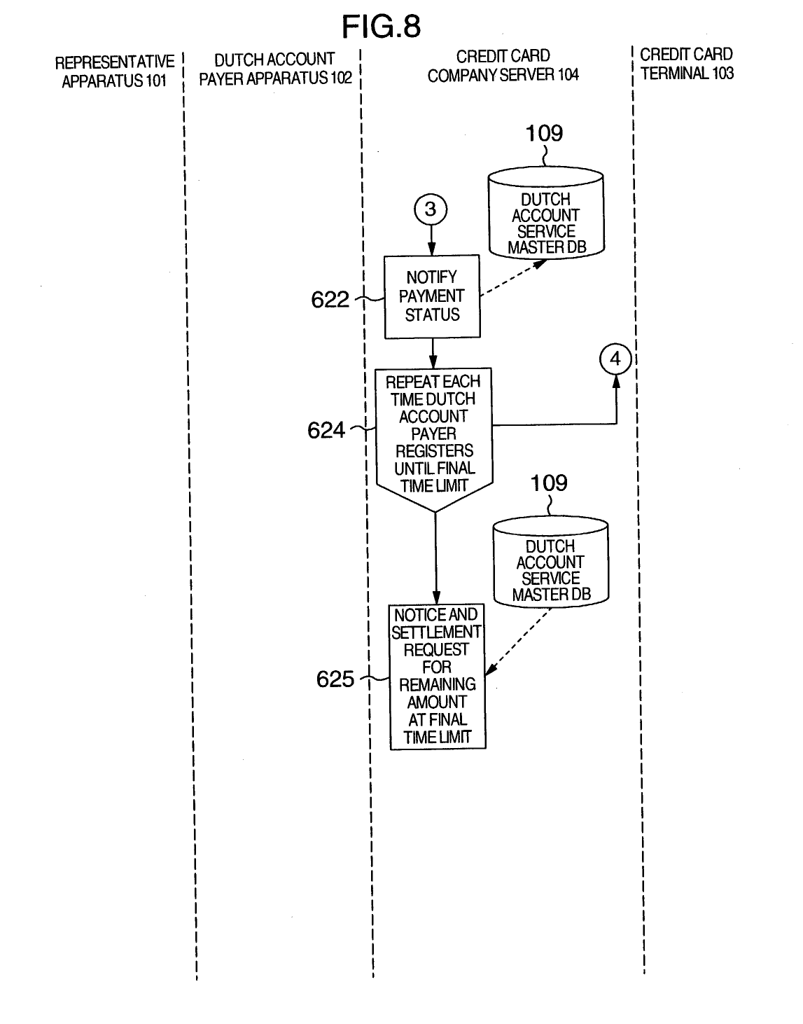

In the second embodiment, in accordance with the service No., each Dutch account payer sets the payment method and conditions to enter money, which differs from the first embodiment using the transaction No. (501). The Dutch account payer conditions master DB of the second embodiment shown in FIG. 8 is the same as DB shown in FIG. 5, excepting that the item transaction No. is changed to the service No. (801). The data table shown in FIG. 10 indicates in an example (811) that Hitachi Taro registers to pay 30,000 Yen by means of reception at a convenience store (a payment method 1 is payment by reception at a convenience store) for the service No. 584364. An example (812) indicates that Hitachi Hanako registers to pay 40,000 Yen by bank transfer (a payment method 2 is bank transfer) for the service No. 584364.

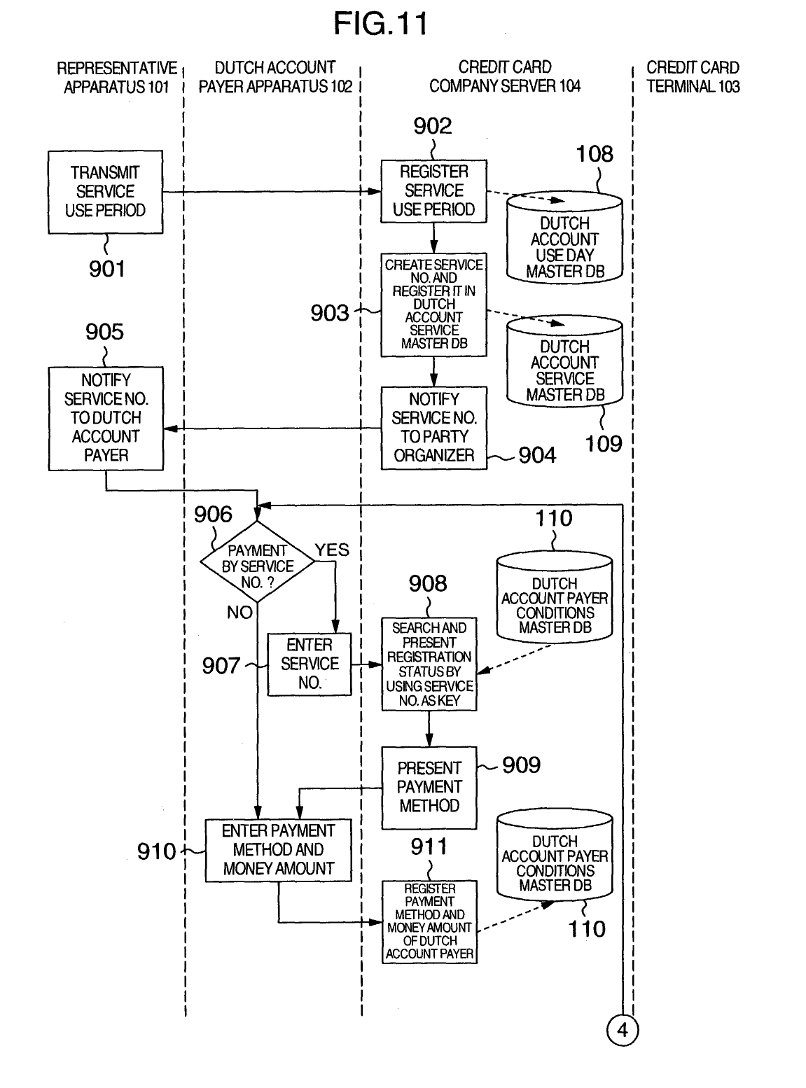

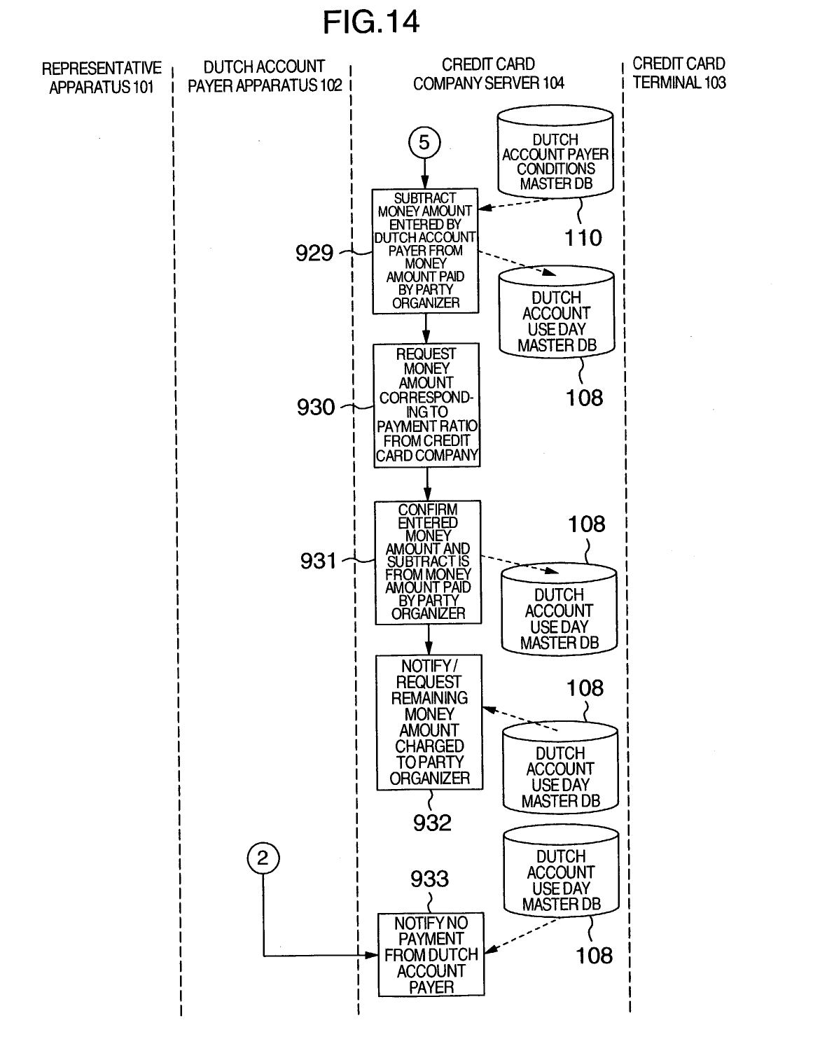

Next, with reference to FIGS. 11 to 14, the process contents of the second embodiment will be described.

Steps 901 and 902 are similar to Steps 601 and 602 shown in FIG. 6.

At Step 903 the credit card company server 104 creates a service No. and stores it in the Dutch account service master DB 109. At Step 904 this service No. is transmitted to the representative apparatus 101.

Next, at Step 905 the representative apparatus notifies the service No. to the Dutch account payer apparatus 102.

Next, at Step 906 in response to an input from the payer i.e., a Dutch account payer, the Dutch account payer apparatus 102 judges whether the payment process using the notified service No. is executed or not. This Step 906 may be omitted. In this case, receiving an input of the service No. (Step 907) or selecting another payment method (Step 910) may be performed.

If it is judged at Step 906 that the payment process using the notified service No. is to be executed, the flow advances to Step 907. If it is judged that the payment process using the notified service No. is not executed, the flow advances to Step 910.

Next, at Step 907 the service No. is received and the service No. is notified to the credit card company server 104. The credit card company server 104 searches the registration status corresponding to the service No. notified at Step 907 from the Dutch account service master DB 109. The payer at the Dutch account payer apparatus 102 determines the money amount to be paid by the payer. A screen for entering this money amount and selecting a payment method is displayed on the Dutch account payer apparatus 102.

At Step 901, the Dutch account payer apparatus 102 receives the payment method and money amount entered by the payer and notifies the payment method and money amount to the credit card company server 104. At Step 911 the credit card company server 104 registers the contents notified at Step 910 to the Dutch account payer conditions master DB 110.

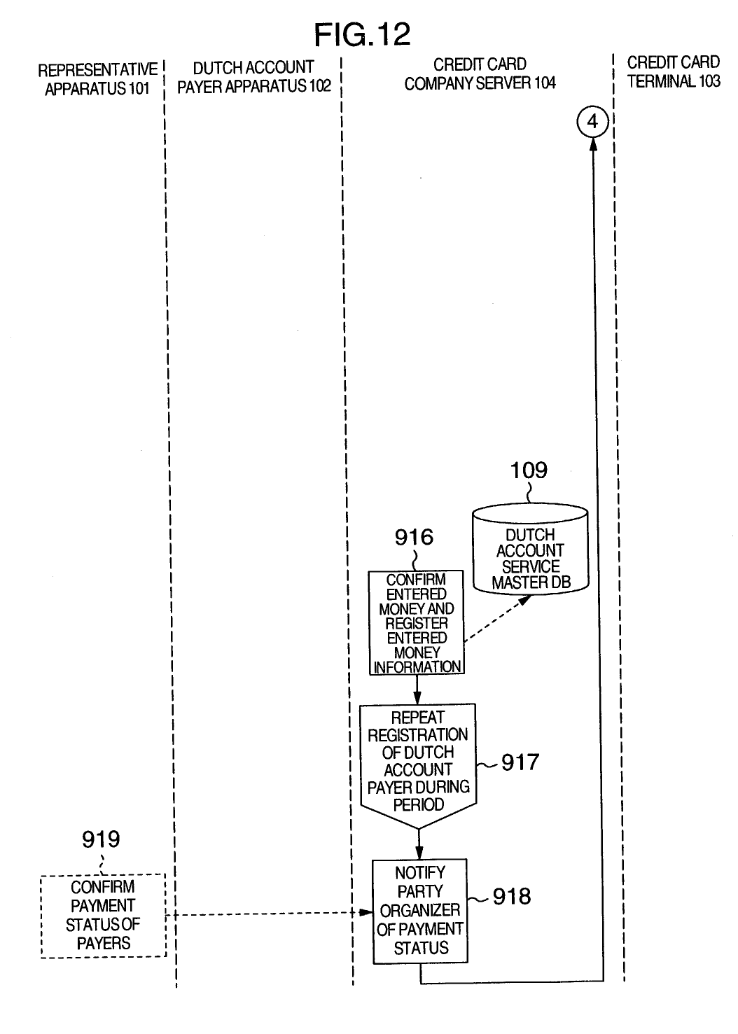

Next, with reference to FIG. 12, the process contents after the payment process will be described. After the payment process corresponding to the selection at Step 910 is executed, at Step 916 entered money information, i.e., information on who entered how much money Yen for which service No., is registered in the Dutch account service master DB. This process is repeated during the period registered at Step 902 (Step 907).

If the payment (entering money) is confirmed or at a predetermined interval, the payment status is notified to the representative apparatus 101 by referring to the Dutch account service master DB. It is therefore possible for the representative (party organizer) to confirm the payment status from the representative apparatus 101 (Step 919). Namely, before receiving the service, payment of some of the Dutch account charge can be received. The second embodiment is effective for the case that a Dutch account ratio (and the value of the services to be received) is known in advance.

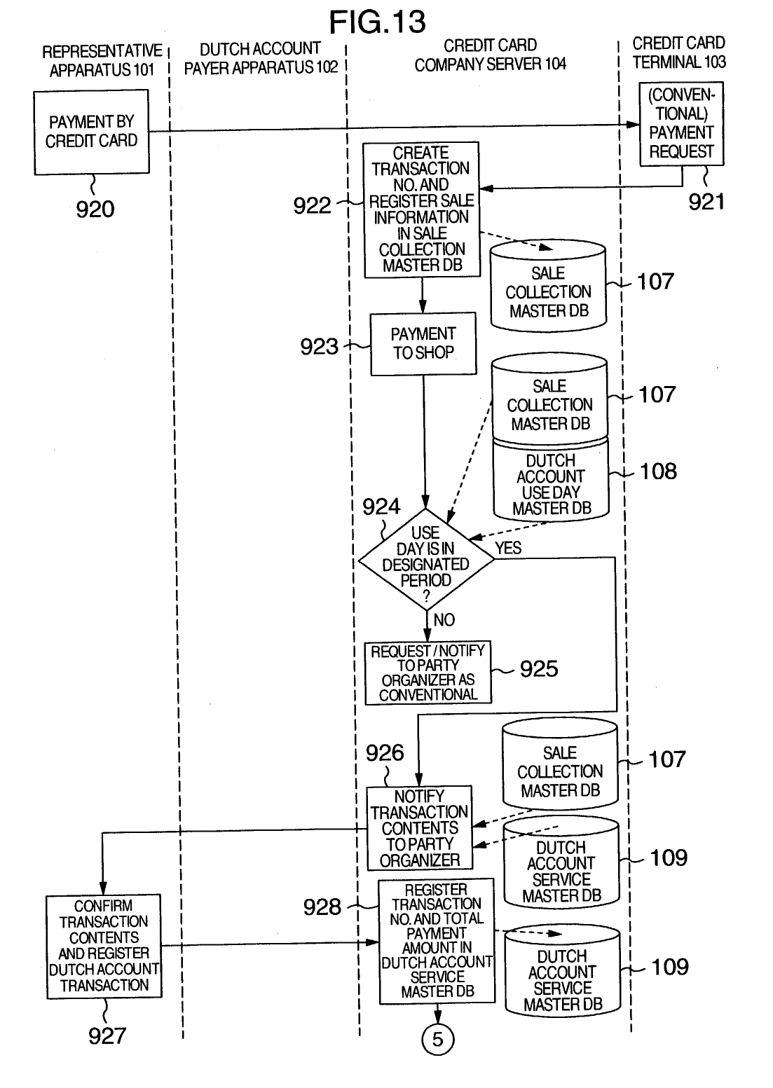

With reference to FIG. 13, the process after the services are provided will be described. Steps 920 to 925 are similar to Steps 603 to 607 shown in FIG. 6. At Step 926, the credit card company server 104 notifies the representative apparatus 101 of the transaction contents including the information of the money amount entered by each Dutch account payer. The representative apparatus 101 outputs the notified contents, and in response to an input by the representative, notifies the credit card company server 104 of the execution of the Dutch account (Dutch account transaction) (Step 927).

Next, at Step 928 the credit card company server 104 registers the contents notified at Step 927 in the Dutch account service master DB 109.

At Step 929, in accordance with the registered contents, the credit card company server 104 subtracts the money amount entered by each Dutch account payer from the money amount charged at Step 921 and paid by the party organizer.

Next, at Steps 930 and 931, each time a Dutch account payer enters the money amount, the credit card company server 104 subtracts this money amount from the money amount paid by the party organizer, and notifies the remaining money to the representative apparatus 101 at a predetermined timing. If the payment is not made after a predetermined period, this effect is notified to the representative apparatus 101 at Step 933.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A Dutch account settlement method which uses a settler apparatus used by a settler and connected via a network to a representative apparatus used by a representative of a Dutch account and an affiliated shop apparatus used by an affiliated shop providing services to execute a Dutch account process for the services received by a plurality of service beneficiaries, wherein:
said settler apparatus
receives settlement request information received by said affiliated shop apparatus from said affiliated shop apparatus, said settlement request information corresponding to a payment process for a value of the services and supplied from the representative of the plurality of service beneficiaries, and said settlement request information including representative identification information for identifying the representative and the value of the services;
judges from said settlement request information and information stored beforehand whether a transaction to be settled by using said settlement request information is to be subjected to a Dutch account process of paying the value by the plurality of service beneficiaries;
if it is judged that the transaction is to be subjected to the Dutch account process, presents transaction identification information for identifying the transaction to the representative apparatus; and
executes a settlement process for a money amount determined by the Dutch account process and to be paid by each of a plurality of payers, the settlement process being executed by using said presented transaction identification information in accordance with an input from each of the plurality of payers.

2. A Dutch account settlement method according to claim 1, wherein said settlement request information is a credit card payment process accepted for the representative.

3. A Dutch account settlement method according to claim 2, wherein said representative identification information is the number of a credit card number used by the representative.

4. A Dutch account settlement method according to claim 1, wherein:
said settler apparatus
accesses a Dutch account payer apparatus used by each of the plurality of payers for the transaction; and
presents information representative of contents of the transaction to said Dutch account payer apparatus if said transaction identification information is input to said Dutch account payer apparatus.

5. A Dutch account settlement method according to claim 4, wherein said transaction identification information is a URL representative of an address at which the information representative of the contents of the transaction is stored.

6. A Dutch account settlement method according to claim 1, wherein:
said settler apparatus
calculates a difference money amount between the value of the services and a money amount settled by the settlement process for the money amount determined by the Dutch account process; and
executes a request process for the representative relative to the calculated difference money amount.

7. A settlement processing apparatus to be used by a settler and connected via a network to a representative apparatus used by a representative of a Dutch account and an affiliated shop apparatus used by an affiliated shop providing services, comprising:
means for receiving settlement request information received by said affiliated shop apparatus from said affiliated shop apparatus, said settlement request information corresponding to a payment process for a value of the services and supplied from the representative of the plurality of service beneficiaries, and said settlement request information including representative identification information for identifying the representative and the value of the services;
means for judging from said settlement request information and information stored beforehand whether a transaction to be settled by using said settlement request information is to be subjected to a Dutch account process of paying the value by the plurality of service beneficiaries;
means for presenting transaction identification information for identifying the transaction to the representative apparatus, if it is judged that the transaction is to be subjected to the Dutch account process; and
means for executing a settlement process for a money amount determined by the Dutch account process and to be paid by each of a plurality of payers, the settlement process being executed by using said presented transaction identification information in accordance with an input from each of the plurality of payers.

8. A settlement processing apparatus according to claim 7, wherein said settlement request information is a credit card payment process accepted for the representative.

9. A settlement processing apparatus according to claim 8, wherein said representative identification information is the number of a credit card number used by the representative.

10. A settlement processing apparatus according to claim 7, further comprising means for:
accessing a Dutch account payer apparatus used by each of the plurality of payers for the transaction; and
presenting information representative of contents of the transaction to said Dutch account payer apparatus if said transaction identification information is input to said Dutch account payer apparatus.

11. A settlement processing apparatus according to claim 10, wherein said transaction identification information is a URL representative of an address at which the information representative of the contents of the transaction is stored.

12. A settlement processing apparatus according to claim 7, further comprising:
means for calculating a difference money amount between the value of the services and a money amount settled by the settlement process for the money amount determined by the Dutch account process; and
means for executing a request process for the representative relative to the calculated difference money amount.

13. A settlement processing apparatus to be used by a settler and connected via a network to a representative apparatus used by a representative of a Dutch account and an affiliated shop apparatus used by an affiliated shop providing services, comprising:
a connection apparatus connectable to the network for receiving settlement request information received by said affiliated shop apparatus from said affiliated shop apparatus, said settlement request information corresponding to a payment process for a value of the services and supplied from the representative of the plurality of service beneficiaries, and said settlement request information including representative identification information for identifying the representative and the value of the services;
a storage device for storing a program; and
a processor connected to said connection apparatus and said storage device for judging from said settlement request information and information stored beforehand whether a transaction to be settled by using said settlement request information is to be subjected to a Dutch account process of paying the value by the plurality of service beneficiaries, for presenting transaction identification information for identifying the transaction to the representative apparatus, if it is judged that the transaction is to be subjected to the Dutch account process and for executing a settlement process for a money amount determined by the Dutch account process and to be paid by each of a plurality of payers, the settlement process being executed by using said presented transaction identification information in accordance with an input from each of the plurality of payers.

14. A settlement processing apparatus according to claim 13, wherein said settlement request information is a credit card payment process accepted for the representative.

15. A settlement processing apparatus according to claim 13, wherein said representative identification information is the number of a credit card number used by the representative.

16. A settlement processing apparatus according to claim 13, wherein said connection apparatus:
accesses via the network a Dutch account payer apparatus used by each of the plurality of payers for the transaction; and
presents information representative of contents of the transaction to said Dutch account payer apparatus if said transaction identification information is input to said Dutch account payer apparatus.

17. A settlement processing apparatus according to claim 16, wherein said transaction identification information is a URL representative of an address at which the information representative of the contents of the transaction is stored.

18. A settlement processing apparatus according to claim 13, wherein said processor calculates a difference money amount between the value of the services and a money amount settled by the settlement process for the money amount determined by the Dutch account process, and executes a request process for the representative relative to the calculated difference money amount.
